(19) United States
(12) Patent Application Publication
(10) Pub. No.: US 2015/0070925 A1
(43) Pub. Date: Mar. 12, 2015

(54) Method for Regulating Light Sources and Apparatus for Practising the Method

(71) Applicant: Tranberg AS, Stavanger (NO)

(72) Inventor: Kjell Are Berg-Hagen, Hommersak (NO)

(73) Assignee: Tranberg AS, Stavanger (NO)

(21) Appl. No.: 14/401,021

(22) PCT Filed: May 15, 2013
(86) PCT No.: PCT/NO2013/050088

§ 371 Date: Nov. 13, 2014

(30) Foreign Application Priority Data
May 16, 2012 (NO) 20120575

(51) Int. Cl. B63B 45/00; F21S 8/00; F21V 14/02

(52) U.S. Cl. CPC B63B 45/00; F21V 14/02; F21S 8/003; F21W 2101/04
USPC 362/523

(57) ABSTRACT

A device is for regulating a light direction of at least one light source on a movable means of transport. The device comprises a direction indicator arranged to indicate a desired light direction for one or more light sources, and a control unit arranged to read the indicated light direction from the direction indicator and, on the basis of the reading information, adjust one or more light sources to the indicated light direction by one or more drivers connected to the control unit. A method is for regulating the light direction of at least one light source on a movable means of transport. A use of a hand-held wireless pointing device is for regulating the light direction of at least one light source arranged on a movable means of transport.

The invention relates to a method of regulating light sources. More specifically, the invention relates to a method for regulating the light direction of one or more light s sources on a movable means of transport, in which a direction indicator is used to indicate the desired light direction for one or more light sources, and in which, on the basis of a signal reading from the direction indicator, a control unit adjusts one or more light sources to the desired light direction by means of one or more drivers connected to the control unit. The invention also relates to a device for practicing the method.

In what follows, the light sources will be exemplified by searchlights on board a vessel, even though the invention is not limited to this. Searchlights are powerful spotlights which may be placed at several points on a vessel, for example, to emit light beams from all directions of the ship so that any floating or fixed objects present in the vicinity of the ship may be identified. Such searchlights on modern ships are equipped with servomotors which can move the searchlight and thereby the direction of the light beam, hereinafter referred to as the light direction, in the horizontal and vertical planes. The control is usually performed by means of so-called joysticks placed in one or more locations on, for example, the bridge. The spotlight itself will often be out of sight to the one who is to control the searchlight. At the start it may therefore take some time before the user is able to inform himself about the direction in which the light is being emitted, in order then to aim the searchlight in the right direction at the desired object. This may result in time-consuming fumbling which may be very undesirable or unfortunate in an emergency in which there is a need for the light beam to be oriented as quickly as possible.

The patent documents WO 2007/030018 and DE 20207444 disclose devices for regulating searchlights on boats, the devices compensating for the motion of the boats so that the searchlight can be focused on a fixed point without following the motion of the boat.

From the patent document WO 02/16824 an apparatus and a method for controlling light sources in an operating theatre are known. The invention includes a pointer which must indicate both an area on a patient desirably to be illuminated and from which direction the light should come. This is solved by providing the pointer with a light source emanating from the back of the pointer; that is to say at the opposite end of the pointer relative to the end pointing towards the desired illuminated area. The light emanating from the back of the pointer is registered by a plurality of cameras that are placed in the ceiling and/or walls of the operating theatre, the cameras being connected to a control unit which, on the basis of a light signal received from the pointer, controls one or more movable light sources in such a way that the area pointed at with the pointer is illuminated from a direction which was indicated through the orientation of the pointer in towards the area desirably to be illuminated.

The patent document WO 2008/093266 A1 discloses an apparatus and a method for controlling stage lights or the like, wherein a pointing device emits a pointing light that forms a pointer in its projection onto a surface in the room, and wherein the pointing device is arranged to change the pointing light as a function of its position in the room. This is used, among other things, to visualize the possible areas of coverage of different stage lights on a stage.

The invention has for its object to remedy or reduce at least one of the drawbacks of the prior art or at least provide a useful alternative to the prior art.

The object is achieved through features which are specified in the description below and in the claims that follow.

In a first aspect, the invention relates to a device for regulating the light direction of at least one light source arranged on a movable means of transport, the device being characterized by including:
a direction indicator arranged to indicate the desired light direction for one or more light sources; and
a control unit arranged to read the indicated light direction from the direction indicator and, on the basis of the reading information, adjust one or more light sources to the indicated light direction by means of one or more drivers connected to the control unit.

The direction indicator may include a transmitter which is arranged to output information about the desired light direction to the control unit. The direction indicated by the direction indicator may alternatively also be read by a sensor, a camera or the like, and information about the desired light-direction reading is transmitted to the control unit from said sensor, camera or the like. The direction indicator may alternatively or additionally be connected to the control unit by means of a wired connection, for example an electrical or optical-fibre cable of a kind known per se.

The advantage of a device in accordance with the present invention is thus that a user does not need to know the orientation of a searchlight, but only needs to indicate the desired light direction. This could save valuable time, both in normal use and in an emergency.

In a preferred embodiment, the direction indicator may be a hand-held, wireless pointing device. This may be, for example, a device specially made for the purpose of regulating the light direction for at least one light source on a movable means of transport, or it may be a mobile phone, a tablet computer or the like including software arranged to communicate with the control unit and thus regulate the light sources. Communication between the hand-held, wireless pointing device and the control unit may take place by means of wireless communication methods known per se, such as various forms of radio-frequency communication.

In a first embodiment, the control unit may be connected to a local reference system arranged to read the light direction indicated by the direction indicator. By a local reference system is meant, in what follows, a reference system that is on the movable means of transport. In one possible embodiment, it may be a reference system that includes sensors, cameras, scanners or the like to read the direction indicated by the direction indicator. The control unit may utilize image-recognition software, triangulation or other technique, known per se, to calculate the desired light direction indicated by the direction indicator and then adjust the light sources by means of said drivers. The direction indicator may in addition emit a light signal which may both be read by the above-mentioned sensors, cameras, scanners or the like but also be used as an orienting means for a user of the direction indicator to get an immediate visual feedback about the indicated light direction. A light source may also be switched off while lo being turned to a new direction and a light source on the direction indicator itself could give a visual indication of the light direction of the light sources. In another possible embodiment, the direction indicator may include one or more accelerometers. In combination with the above-mentioned sensors, cameras, scanners or the like, the directional indications of the direction indicator could then be read in a way corresponding to that of modern game consoles like Nintendo Vii® and PlayStation Move®, for example. It is also known that the communication systems of said game consoles are arranged to read rotation around an axis substantially parallel to a longitudinal axis of the hand control of the game console so that rotational movements can be read. Thus, it will also be possible to utilize prior art to read rotational movements around a longitudinal or transversal axis of the direction indicator as well. The latter will be particularly appropriate if the direction indicator is a hand-held, wireless pointing device. The rotational movements could be used, for example, to focus and/or dim/brighten a light source. The local reference system may also include a synchronizer including a transmitter (“synchro transmitter”) and a receiver (“synchro receiver”) of a kind known per se.

In a second embodiment, the control unit may, as an alternative or in addition, be connected to a global reference system arranged to read the light direction indicated by the direction indicator. The global reference system may be a magnetic field of the Earth and/or a GPS network.

The direction indicator may, for example, be provided with one or more compasses. The direction indicator is directed in the desired light direction for one or more light sources, and the compass reading is transmitted to the control unit which then adjusts said one or more light sources to the direction indicated by the direction indicator. As an alternative, or in addition, the direction indicator may also be provided with a GPS.

It may also be an advantage if the direction indicator is provided with one or more devices arranged to measure the deviation of the light direction indicated by the direction indicator from the horizontal plane. This may be, for example, a gyroscope, a spirit level, an accelerometer or combinations thereof. If the device arranged to measure deviations from the horizontal plane is used together with a compass and/or a GPS, the control unit could receive a complete directional indication for the desired light direction in both the horizontal and the vertical planes. The device for measuring deviations from the horizontal plane could also be used together with a local reference system.

In one embodiment, the control unit may be connected to a compensator arranged to keep the light direction of a light source substantially constant independently of the movement of the movable means of transport. This will be practical if the movable means of transport is moving and it is desirable to aim the light in a particular direction or at a particular object outside the movable means of transport. In one embodiment, it may be a device for the movement compensation of searchlights on a vessel as disclosed in the patent document WO 2007/030018. The compensator may contain one or more of the following devices:
a compass
a GPS,
an accelerometer,
a gyroscope, and
a spirit level, and combinations thereof. In a case in which it is an area on the means of transport itself which is to be illuminated, for example the cargo deck of a ship, there will be no need for said compensator.

In one embodiment, the device could additionally include one or more position sensors arranged to sense the position of the direction indicator on the movable means of transport. This could be particularly appropriate in a case in which there is a relatively large distance between the direction indicator (with its operator) and the searchlight that is to be adjusted to a desired direction, so that there will be a difference between the direction indicated by the direction indicator and the actual light direction from the at least one light source. This may be explained by a simple example in which a user, with the direction indicator in his hand, is standing on the bridge of a vessel, pointing in the direction of an area in front of himself to illuminate an area between the bridge and the bow. If a searchlight at the bow of the vessel has been activated, it will, without any form of correction, shine beyond the bow in the direction indicated by the direction indicator and not in the desired direction on deck. To avoid such cases, it may be appropriate to detect the position of the direction indicator on the movable means of transport so that by the use of known techniques known per se, this deviation could be compensated for by means of the control unit. Said sensors may, for example, be of the radio-frequency identification (RFID) type or the electro-optical type. In other embodiments, there will be no need to take the difference between the direction indicated by the direction indicator and the actual light direction of a light source into account, as the distance between the direction indicator and the light source may often be relatively small. On a vessel, most searchlights will be placed near the bridge, where the operator of the direction indicator will usually be as well, so that said difference will be small and in most cases negligible.

In a second aspect, the invention relates to a method for regulating the light direction of at least one light source arranged on a movable means of transport, the method being characterized by including the following steps:
indicating the desired light direction for one or more light sources by means of a direction indicator;
by means of a control unit, reading the light direction indicated by the direction indicator; and
on the basis of the indicated-light-direction reading, adjusting one or more light sources to the indicated light direction by means of one or more drivers connected to the control unit.

In a preferred embodiment, the method may include indicating the desired light direction for the at least one light source by means of a direction indicator which is a handheld, wireless pointing device.

A movable means of transport is described as well, including a device for adjusting the light direction of at least one light source in accordance with the above-mentioned description.

The movable means of transport may be a vessel.

In a third aspect, the invention relates to the use of a hand-held, wireless pointing device to indicate the desired light direction of at least one light source on a movable means of transport.

In what follows, an example of a preferred embodiment is described, which is visualized in the accompanying drawings, in which:

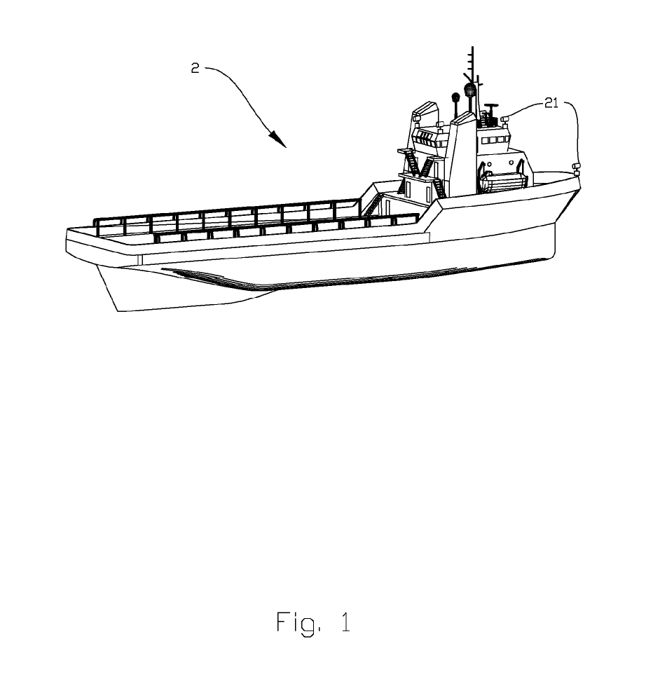

FIG. 1 shows, in perspective, a vessel provided with light sources as used in the present invention;

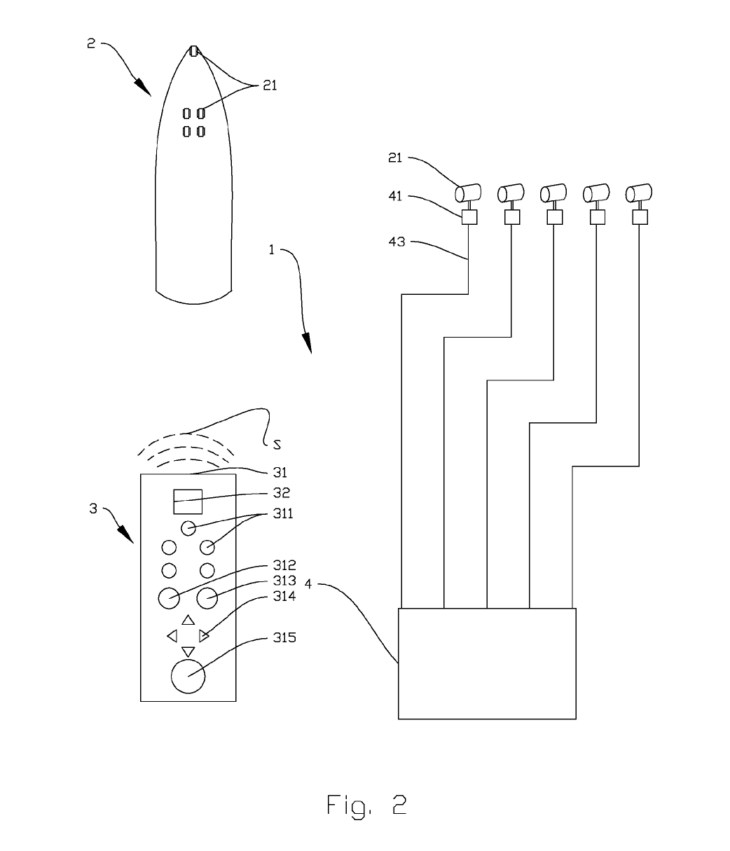

FIG. 2 shows schematically an overview of some components as used in the present invention;

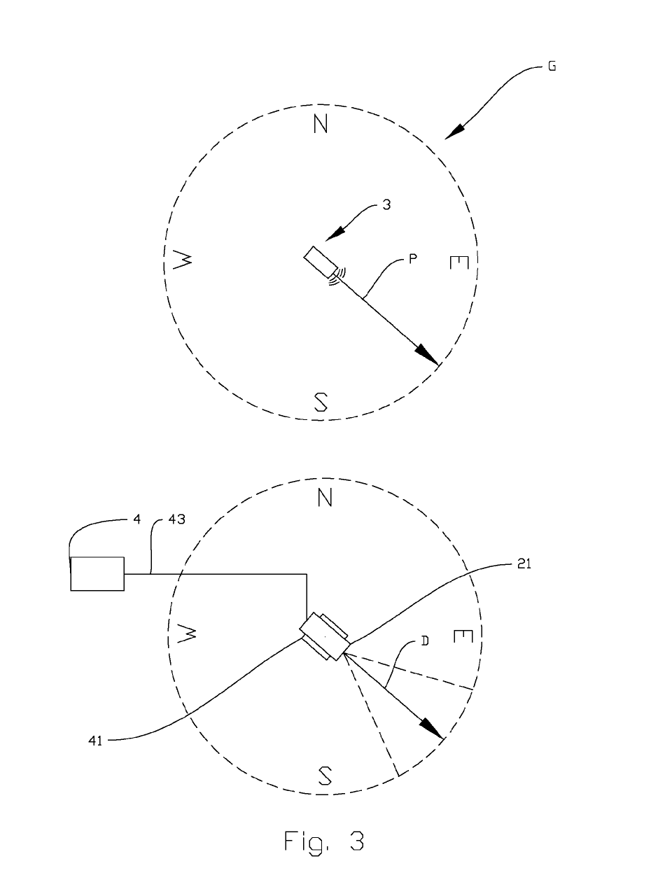

FIG. 3 shows schematically a first embodiment of the present invention, viewed from above;

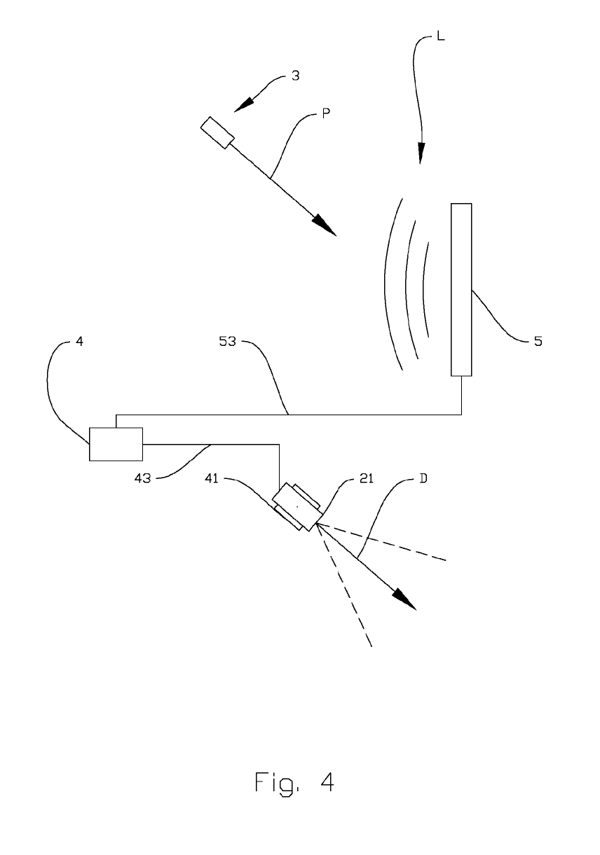

FIG. 4 shows schematically a second embodiment of the present invention, viewed from above;

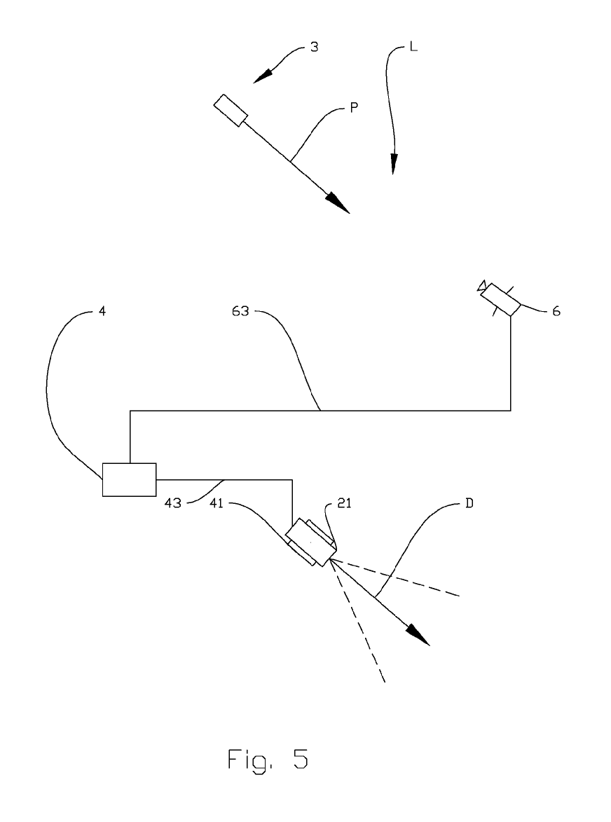

FIG. 5 shows schematically a third embodiment of the present invention, viewed from above;

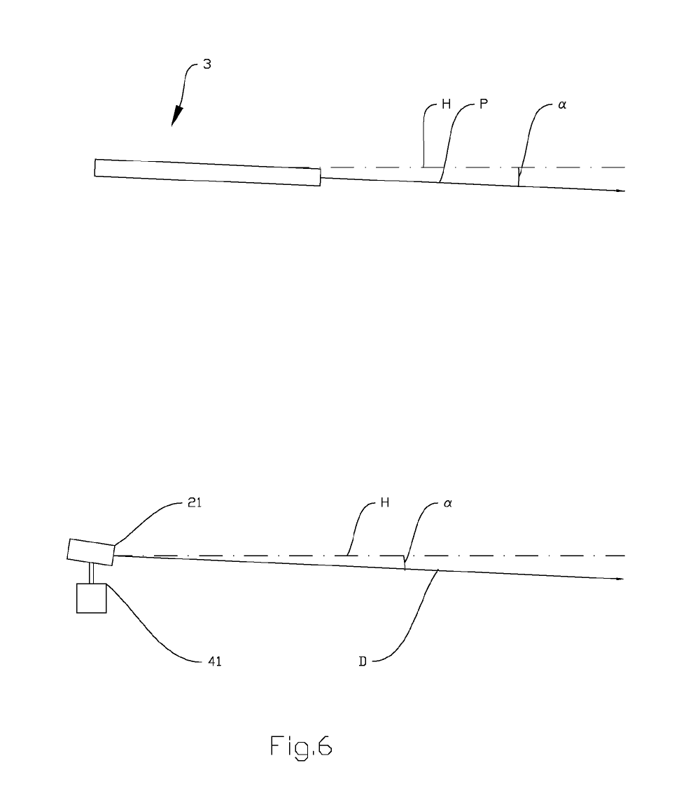

FIG. 6 shows schematically, in a side view, a direction indicator indicating deviations from the horizontal plane; and

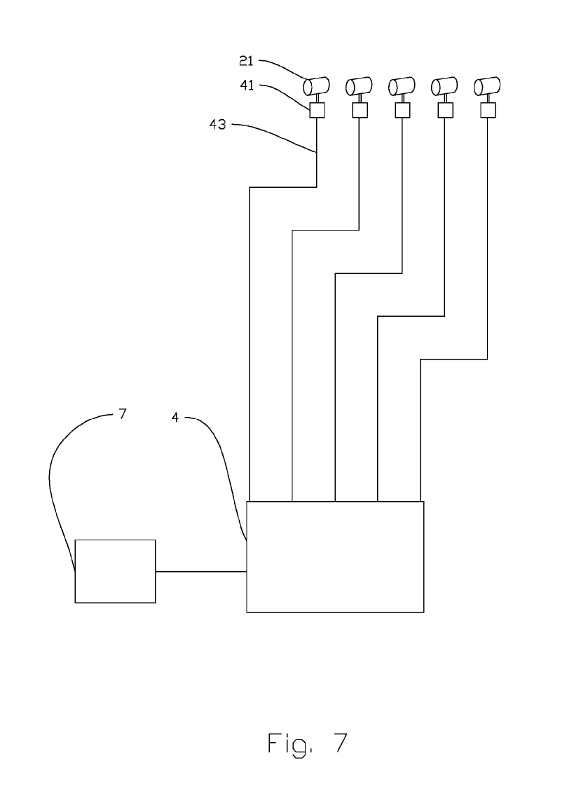

FIG. 7 shows schematically an overview of some components as used in the present invention.

In what follows, the reference numeral 1 indicates a device in accordance with the present invention. Several of the figures are shown in a schematic and highly simplified manner.

In FIG. 1, a movable means of transport 2 is shown in the form of a vessel. The vessel 2 is provided with a plurality of light sources 21 in the form of searchlights. In the figure, the vessel 2 is shown as provided with five searchlights 21, four of which are placed at the bridge of the vessel 2 and one is placed at the bow of the vessel 2. In alternative embodiments, the number and positioning of the searchlights 21 may vary, but a majority of the searchlights 21 will often be placed at or near the bridge of the vessel 2.

FIG. 2 shows a schematic layout of one embodiment of the present invention. Different parts of the figure are indicated in different scales for the sake of clarity. The vessel 2 from FIG. 1 is shown from above on a small scale at the top, left, in the figure and the positioning of the different searchlights 21 on the vessel 2 is indicated in the figure. The figure also shows the five searchlights 21 on a larger scale, separate from the vessel 2 and connected to a control unit 4 by means of cables 43 via drivers 41. The drivers 41 may be servomotors, and the cables 43 may be signal and/or power cables, both of types known per se. In alternative embodiments, not shown, the searchlights 21 may be connected in a wireless manner to the control unit 4 via the drivers 41 by means of wireless communication technology known per se. A direction indicator 3 in the form of a pointing device is shown at the bottom, left, in the figure, on a larger scale than the vessel 2 and the separate searchlights 21. The pointing device 3 includes a transmitter 31 arranged to transmit a signal S. The pointing device 3 is shown as a unit resembling a remote control with a built-in compass 32. In the figure, the pointing device 3 is shown as provided with a plurality of different push-buttons/switches. Five push-buttons 311 on an upper portion of the pointing device 3 represent the five different searchlights 21 on the vessel 2, and, for the sake of clarity, the positions of the push-buttons 311 represent the positions of the searchlights 21 on the vessel. By pressing one or more of the push-buttons 311, one or more of the searchlights 21 on the vessel 2 is/are selected. At the middle portion of the pointing device 3, there are two slightly larger push-buttons 312, 313 representing on and off, respectively. This means that the push-buttons 312, 313 may be used to switch a searchlight selected via the push-buttons 311 on and off. Further, the pointing device 3 includes a set of arrow-shaped push-buttons 314 which may be used to fine-tune a searchlight 21. A larger push-button 315 on a lower portion of the pointing device may be used to direct all the searchlights 21 in a pre-selected starting direction, wherein the pre-selected staring direction may be set to be a different one for each individual searchlight 21.

FIG. 3 indicates schematically, in a view from above, the use of the pointing device 3 in accordance with a first embodiment of the present invention, wherein the pointing device 3 outputs a signal S to the control unit 4 based on information read via a global reference system G, in the form of the Earth's magnetic field, which is drawn as a broken-line circle in the figure with the cardinal points indicated on the inside of the circle. In the upper part of the figure, the pointing device 3 is shown, which is pointing in a pointing direction P. By pressing one or more of the push-buttons 311, a user, not shown, first indicates which searchlight or searchlights 21 is/are to be activated. The user then points the pointing device 3 in the pointing direction P, in which said one or more of the searchlights 21 should desirably orient itself/themselves. The compass 32 of the pointing device 3 is oriented according to the pointing direction P and the orientation is recorded and transmitted to the control unit 4 by means of the transmitter 31. The control unit 4 then orients said one or more searchlights 21 in a desired light direction D by means of the drivers 41. The light direction D coincides with the pointing direction P. In the figure, for the sake of clarity, one searchlight 21 has been drawn inside a circle corresponding to that of the pointing device 3. The light direction D of the searchlight 21 is also enclosed in broken lines which indicate the spreading of the light around the light direction D.

In FIG. 4, the use of a pointing device 3 in accordance with a second embodiment of the present invention is shown schematically, viewed from above, wherein a local reference system L is used to sense the pointing direction P of the pointing device 3. A sensor 5 is arranged to sense the pointing direction P of the pointing device 3. The sensor 5 may be of a type known per se, as mentioned in the general part of the application, for example of the infrared type. The pointing device 3 may further be provided with one or more accelerometers which, together with the sensor 5, will be arranged to read the pointing direction P of the pointing device 3 and then send the signal reading to the control unit 4 via a cable 43, whereupon the control unit 4 turns one or more searchlights 21 in the indicated light direction D by means of drivers 41.

In FIG. 5, yet another embodiment of the use of a pointing device 3 in accordance with the present invention is shown schematically in a view from above. A local reference system L in the form of a camera 6 is used to determine the pointing direction P of the pointing device 3. The camera 6 may be used, together with image-processing software, triangulation or other methods known per se, to calculate the pointing direction P of the pointing device 3 in the control unit 4. The reading information about the pointing direction P of the pointing device 3 is transmitted to the control unit 4 via the cables 43, whereupon, on the basis of information received, the control unit 4 calculates the desired light direction D for one or more searchlights 21.

In FIG. 6, it is shown schematically how the pointing direction P of the pointing device 3 may deviate from the horizontal plane H. A deviation a may be sensed by means of various devices mentioned in the general part of the application. The sensed deviation a from the horizontal plane H may be transmitted by means of the transmitter 31 of the pointing device 3 to the control unit 4, which is not shown in this figure, the control unit 4 adjusting one or more searchlights 21 to the indicated light direction D by means of one or more drivers 41 as mentioned above. The rotation of the pointing device 3 around its own longitudinal axis and/or transverse axis could also be read in a corresponding way, not shown. The latter rotational movements could be used, for example, to focus one or more searchlights 21.

In FIG. 7, an embodiment of the invention in which the control unit 4 is connected to a compensator 7 is shown schematically. The compensator 7 is arranged to keep the light direction D of a searchlight 21 fixed, independently of the movements of the vessel 2. Such a compensator 7 is described, among other things, in the abovementioned patent document WO 2008/093266 A1.

1. A device for regulating a light direction of at least one light source arranged on a movable means of transport, wherein the device comprises:
a direction indicator arranged to indicate a desired light direction for one or more light sources; and
a control unit arranged to read the indicated light direction from the direction indicator and, on the basis of the reading information, adjust one or more light sources to the indicated light direction by one or more drivers connected to the control unit.

2. The device in accordance with claim 1, wherein the direction indicator includes a transmitter.

3. The device in accordance with claim 1, wherein the direction indicator is a hand-held wireless pointing device.

4. The device in accordance with claim 1, wherein the control unit is connected to a local reference system arranged to read the light direction indicated by the direction indicator.

5. The device in accordance with claim 1, wherein the control device is connected to a global reference system arranged to read the light direction indicated by the direction indicator.

6. The device in accordance with claim 5, wherein the direction indicator is provided with a compass.

7. The device in accordance claim 1, wherein the direction indicator is provided with a device arranged to measure a difference between the light direction indicated by the direction indicator and the horizontal plane.

8. The device in accordance with claim 1, wherein the control unit includes a compensator arranged to keep the light direction of a light source substantially constant independently of the motion of the movable means of transport.

9. The device in accordance with claim 1, wherein the device includes one or more position sensors arranged to sense the position of the direction indicator on the movable means of transport.

10. A method for regulating a light direction of at least one hat source arranged on a movable means of transport, wherein the method comprises:
indicating the desired light direction for one or more light sources with a direction indicator;
reading the light direction indicated by the direction indicator with a control unit; and
on the basis of the indicated-light-direction reading, adjusting one or more light sources to the indicated light direction with one or more drivers connected to the control unit.

11. The method in accordance with claim 10, wherein the method comprises
indicating the desired light direction with a direction indicator which is a hand-held, wireless pointing device.

12. A movable means of transport comprising:
a device for regulating the light direction of at least one light source, the device comprising:
a direction indicator arranged to indicate a desired light direction for one or more light sources; and
a control unit arranged to read the indicated light direction from the direction indicator and, on the basis of the reading information, adjust one or more light sources to the indicated light direction by one or more drivers connected to the control unit.

13. The movable means of transport in accordance with claim 12, wherein the movable means of transport is a vessel.

14. (canceled)
